(19) United States
(12) Patent Application Publication
(10) Pub. No.: US 2006/0150890 A1
(43) Pub. Date: Jul. 13, 2006

(54) Horn assembly

(76) Inventor: Wayne Cohen, Bangkok (TH)

Correspondence Address: DORSEY & WHITNEY LLP;INTELLECTUAL PROPERTY DEPARTMENT, 250 PARK AVENUE, NEW YORK, NY, 10177, US

(21) Appl. No.: 11/330,012

(22) Filed: Jan. 10, 2006

Related U.S. Application Data
(60) Provisional application No. 60/644,047, filed on Jan. 13, 2005.

(51) Int. Cl. G10K 9/04

(52) U.S. Cl. 116/142 FP

(57) ABSTRACT

A horn assembly and method of making such horn assembly are provided. For example, the horn may be easily assembled and disassembled without requiring an adhesive. The horn assembly can include a first arrangement and a second arrangement. The first arrangement may have a sound generating assembly. The second arrangement can be adapted to provide sound therethrough. The second arrangement may be coupled to the first arrangement by pressure fitting the second arrangement to the first arrangement, without requiring the application of the adhesive.

### CROSS-REFERENCE TO RELATED APPLICATION(S)

This application claims priority from U.S. Provisional Patent Application No. 60/644,047 entitled “COLLAGE SPORTS HORN” filed on Jan. 13, 2005, the entire disclosure of which is incorporated herein by reference.

### FIELD OF THE INVENTION

This invention relates generally to horn assemblies, and more specifically to easily assembled horn assemblies.

### BACKGROUND INFORMATION

During a variety of events, such as sporting events, it may be desirable for patrons to generate noise. For example, during a football game, fans may generate noise to indicate their approval or disapproval of occurrences in play actions, and/or to generally show support for their team. At a football game, fans typically generate noise in an effort either to urge on the team one wishes to support or to distract the opposing team.

In creating noise, fans often clap their hands, stamp their feet, or use their voices to shout or yell. In some situations, fans roll programs to produce a makeshift horn. Thus, at such spectator events, one may see spectators forming their programs into a horn shaped configuration to more fully project sound.

The use of a membrane in conjunction with air to generate sound is known. High acoustic output horns producing tonal sounds are thus produced for use by sports fans or other individuals, such that sounds may be generated by blowing through a hole of the horn.

There remains a need for providing a lightweight, inexpensive horn that takes little space but which may be assembled to be able to produce a loud, clear tone, for use, for example, in a sports stadium.

### SUMMARY OF THE INVENTION

A horn assembly and method of making such horn assembly according to an exemplary embodiment of the present invention is provided, to address such need such that the horn may be easily assembled and disassembled, without requiring an adhesive to be used. The horn assembly comprises a first arrangement and second arrangement. The first arrangement comprises a sound generating assembly. The second arrangement can be adapted to provide sound therethrough. The second arrangement may be coupled to the first arrangement by pressure fitting the second arrangement to the first arrangement without requiring applying an adhesive thereto. Either or both of the first and second arrangements may be externally customized to show support for a team, reflect a sponsor logo, or other. The horn assembly may be easily assembled and disassembled.

For example, the first arrangement can include a sound generating assembly. In one exemplary embodiment of the present invention, the sound generating assembly may include an elastic membrane or diaphragm and an inlet tube. A membrane cover having air vents may be provided for protecting the elastic membrane. The first arrangement may further include an attachment device for receiving the second arrangement.

The second arrangement can be adapted to provide sound therethrough. In one exemplary embodiment of the present invention, the second arrangement may include a sheet that may be wrapped with side edges overlapping to form the horn. A narrow mouth end of the horn can be coupled to the first arrangement to form the horn assembly.

The air vents of the membrane cover may be provided in a customized configuration. For example, the air vents may be provided in a logo configuration. Similarly, the sheet may customized. For example, the sheet be printed with, or otherwise provided with, a logo.

While multiple embodiments are disclosed, still other embodiments of the invention will become apparent to those skilled in the art from the following detailed description, which shows and describes illustrative embodiments of the invention. As will be realized, the invention is capable of modifications in various obvious aspects, all without departing from the spirit and scope of the invention. Accordingly, the drawings and detailed description are to be regarded as illustrative in nature and not in any way restrictive.

### BRIEF DESCRIPTION OF THE DRAWINGS

FIG. 1 is a right side cross-sectional view of a horn assembly in accordance with a first exemplary embodiment of the present invention.

FIG. 2 is an exploded view of the horn assembly of FIG. 1 provided in separate sections.

FIG. 3 is a top cross-sectional view of the horn assembly of FIG. 1.

FIG. 4 is a left side view of the horn assembly of FIG. 1.

FIG. 5 is a top view of the horn assembly of FIG. 1.

FIG. 6 is a front perspective view of the horn assembly of FIG. 1.

FIG. 7 is a rear perspective view of the horn assembly of FIG. 1.

FIG. 8 is a top view of a horn assembly in accordance with a second exemplary embodiment of the present invention.

FIG. 9 is a side view of the horn assembly of FIG. 8.

FIG. 10 is a front perspective view of the horn assembly of FIG. 8.

FIG. 11 is a rear perspective view of the horn assembly of FIG. 8.

FIG. 12 is a rear view of a first arrangement of the horn assembly of FIG. 8.

FIG. 13 is a front view of the first arrangement of the horn assembly of FIG. 8.

FIG. 14 is a rear view of a variant of the first arrangement of the horn assembly of FIG. 8.

FIG. 15 is a top view of a two-horn horn assembly in accordance with an exemplary embodiment of the present invention.

FIG. 16 is an exploded perspective view of the two-horn horn assembly of FIG. 15 provided in separate sections in accordance with one embodiment of the present invention.

FIG. 17 is a top perspective view of the two-horn horn assembly of FIG. 15.

FIG. 18 is a bottom perspective view of the two-horn horn assembly of FIG. 15.

FIG. 19 is a rear view of the two-horn horn assembly of FIG. 15.

### DETAILED DESCRIPTION

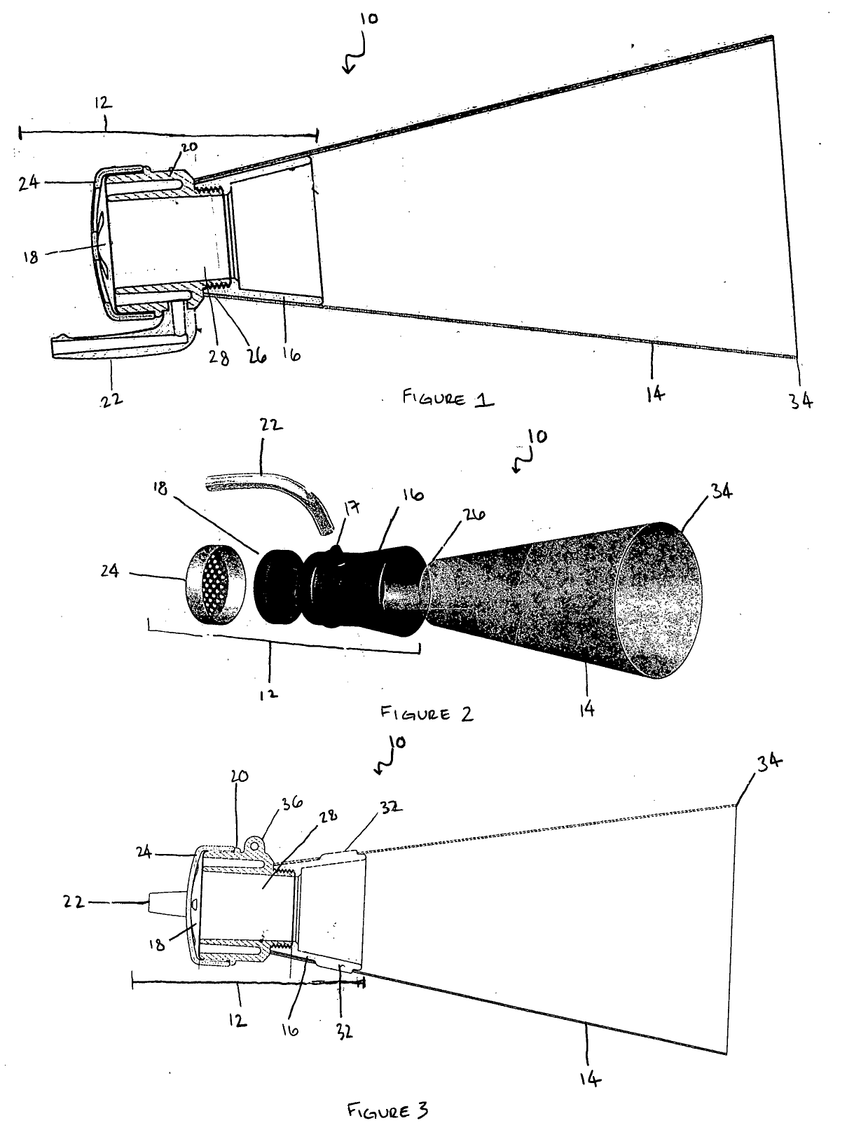

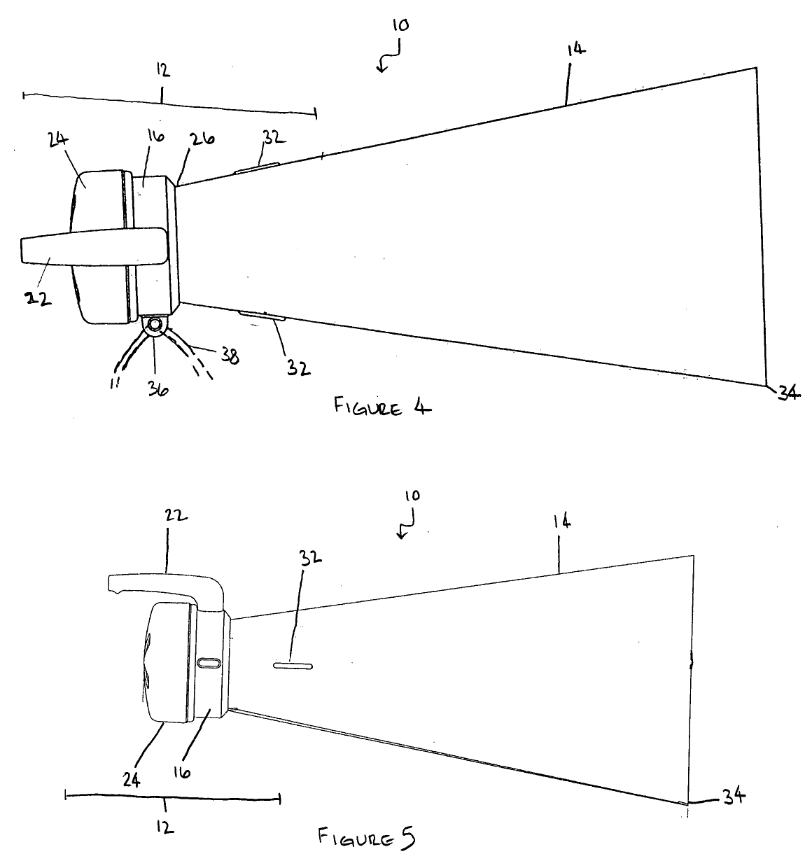

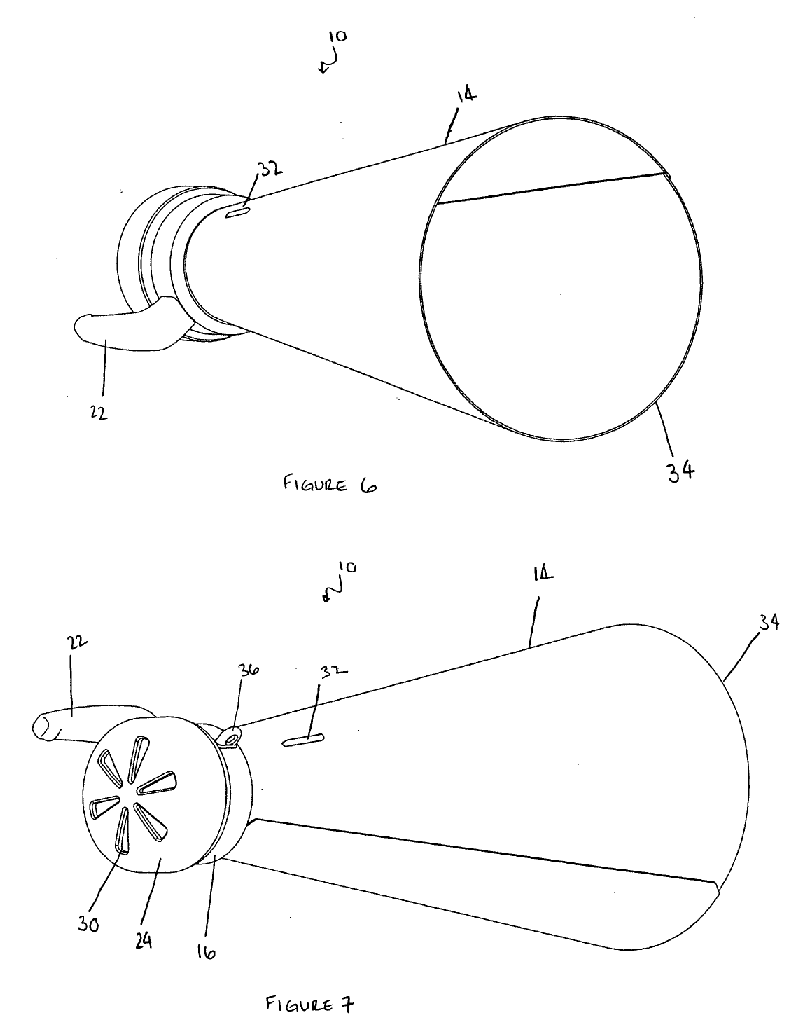

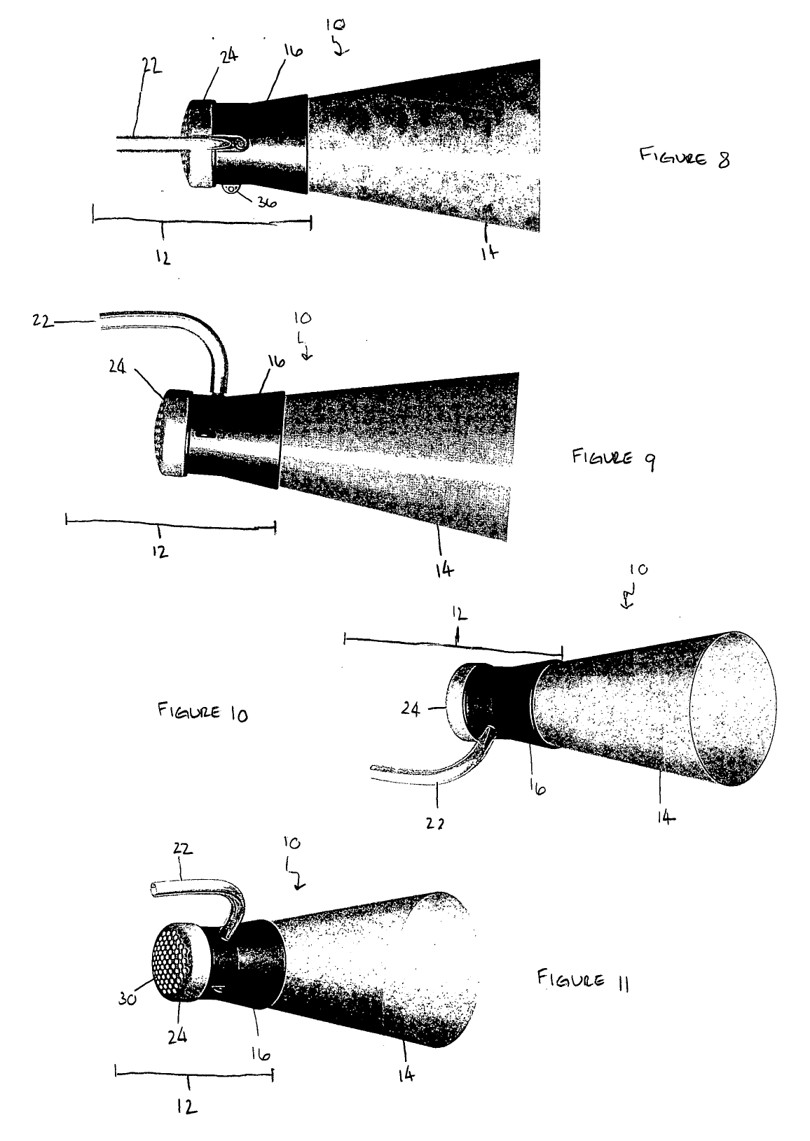

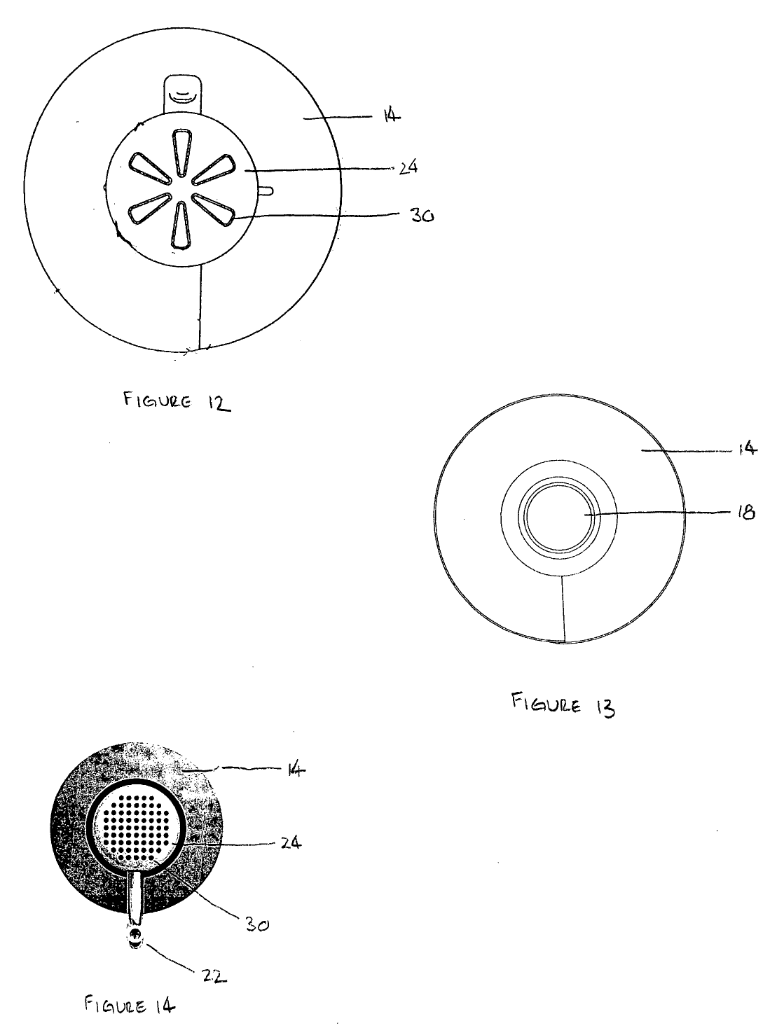

FIGS. 1-14 illustrate single-horn horn assemblies according to exemplary embodiments of the present invention. FIGS. 1 and 3 illustrate cross-sectional views of one exemplary embodiment of the assembled horn assembly. FIG. 2 illustrates an exploded perspective view of the horn assembly of FIGS. 1 and 3. FIGS. 4 through 11 illustrate perspective views of various embodiments single-horn horn assemblies according to the present invention which includes a mouthpiece and a horn.

As shown in these figures, each horn assembly 10 includes a first arrangement 12 and a second arrangement 14. The second arrangement 14 is coupled to the first arrangement 12 by pressure fitting the second arrangement 14 to the first arrangement 12 without requiring an application of an adhesive. The first arrangement 12 includes a sound generating assembly. In the exemplary embodiment shown in FIGS. 1-3, the sound generating assembly includes an elastic membrane or diaphragm 18, a base structure 20 and an inlet tube 22. The first arrangement 12 may further include an attachment device 16 for coupling the second arrangement 14 to the first arrangement 12. The components may be provided separately or preassembled as a complete first arrangement 12. A membrane cover 24 may further be provided with the first arrangement 12.

The elastic membrane or diaphragm 18 can be located at the input or a reduced diameter end 26 of the horn assembly 10 when assembled. The elastic membrane 18 may be manufactured of any suitable material. For example, the elastic membrane 18 may be manufactured of silicone, latex, vinyl, mylar, or other material. Vibrations of the membrane 18 can be induced by air flow generated between the membrane 18 and an adjacent housing 28 in the base structure 20. The membrane 18, in combination with the housing 28, may form a substantially sealed chamber. The sealed chamber provides rebounding compression against the membrane 18 as the membrane 18 is forced or expended into the chamber by the air flow. By placing one's mouth on the tube 22 and blowing there through, air flows past the membrane 18 and out of the second arrangement 14. The horn assembly 10 thus provides a sound. Another way of sounding the horn assembly may be provided. For example, a compressed air source (as known to those skilled in the art) may be coupled to the first arrangement for generating air flow at or past the membrane 18.

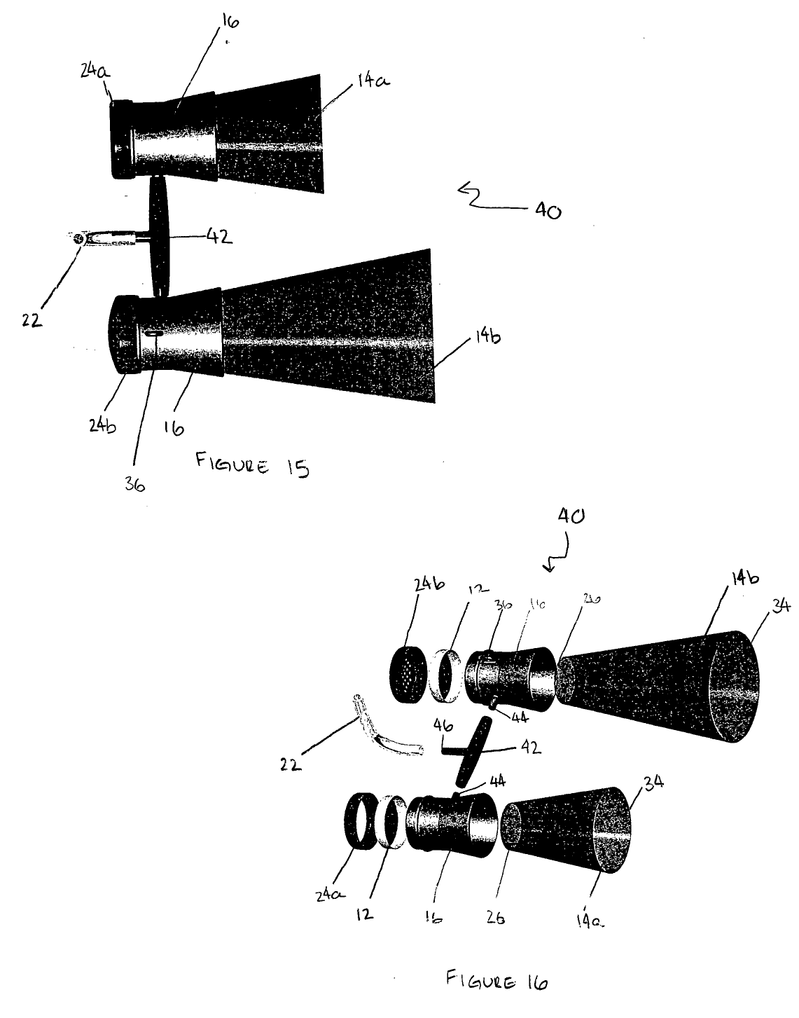

A membrane cover 24 may be provided for the horn assembly 10 for protecting the elastic membrane 18. The membrane cover 24 may be provided for user replacement of the elastic membrane 18 and/or situated on the first arrangement 12. Air vents 30 (see FIGS. 12 and 14) are provided on the membrane cover 24 such that air may pass externally of the first arrangement 12 to the membrane 18. The air vents 30 may be customized, for example, as a mascot or a logo.

An inlet tube 22 may provide for the horn assembly for blowing air across the elastic membrane 18. For example, the attachment device 16 may be provided with an extension 17 for receipt by the inlet tube 22. The placement of the extension 17 in the inlet tube 22 can operate to couple the inlet tube 22 to the attachment device 16, and thereby to the horn assembly 10. Alternately, any suitable manner of coupling the inlet tube 22 to the horn assembly 10 may be implemented. Any suitable material may be used for manufacturing the inlet tube 22. For example, a rigid plastic such as high impact styrene may be used. Alternately, a soft material with, for example, a rubber-like feel may be used. In some exemplary embodiments, a soft material may be advantageous for use so as to reduce the likelihood of injury to the user's face or teeth. As stated above, alternate ways for generating air flow across the elastic membrane 18 may be used instead of or in addition to the use of the inlet tube 22.

An attachment device 16 couples the second arrangement 14 to the base structure 20 without requiring applying an adhesive, as described in further detail below.

In the exemplary embodiments shown in the figures, the second arrangement 14 can include a sheet being shaped to have a frustoconical form, and having first and second side edges. A logo or design may be provided on the sheet such that, for example, a sponsor may advertise on the horn assembly 10. The sheet may be formed of any suitable material such as, for example, paper with plastic lamination, paper without lamination, plastic sheet material, or other. In forming the second arrangement 14, the sheet can be effectively rolled with the first and second side edges overlapping so as to form, e.g., a frustoconical shape. The second arrangement 14 may be secured in this position in any suitable manner. Thus, for example, the first and second edges of the sheet of the second arrangement 14 may be formed with suitable interlocking edge configurations. For example, edge arms may be provided on the first edge with edge slots for receiving the edge arms on the second edge. In alternate exemplary embodiments, the edges may be secured using an adhesive.

As shown in FIGS. 3-7, locating tabs 32 may be provided on the attachment device 16 for aiding in coupling the second arrangement 14 to the attachment device 16. If the locating tab 32 are provided, corresponding slots are preferably also provided on the second arrangement 14 for receiving the locating tabs 32. The locating tabs 32 extend through the slots, thus both ensuring position of the second arrangement 14 vis-á-vis the first arrangement 12, and reinforcing the coupling of the second arrangement 14 to the first arrangement 12. Further, if a logo or design is provided on the second arrangement 14, the locating tabs 32 may be used to ensure correct placement of the logo or design on the assembled horn assembly 10.

When rolled and secured, the second arrangement 14 has a relatively narrow coupling end 26, and expands outwardly in a frusto conical configuration, terminating in a sound transmitting end 34 of larger dimensions than the coupling end 26. The dimensions of the second arrangement 14 may be modified for any reason, and possibly to alter the pitch of the horn assembly 10. Thus, for example, the second arrangement 14 that is slightly shorter in the axial direction may have an increased pitch.

The second arrangement 14 may be provided as a flat sheet or preassembled into a horn configuration. For example, it may be desirable to minimize shipping and storage space. Thus, the horn assemblies' portions may be shipped as flat sheets. In other examples, it may be desirable to ship the horn assemblies' portions in stacks of preassembled horns.

A lanyard holder 36 may also be provided. As shown in FIGS. 3, 4, 7, 15 and 18, the lanyard holder 36 can be integral with the attachment device 16. Alternately, the lanyard holder 36 may be provided in an alternate location on the horn assembly 10. A lanyard 38 may be inserted through the lanyard holder 36, and the horn assembly 10 may be worn around a user's neck.

To assemble the horn assembly 10, the first arrangement 12 can be coupled to the coupling end 26 of the second arrangement 14. The attachment of the first arrangement 12 to the second arrangement 14 may be performed using a releasable coupling or a permanent coupling. The attachment device 16 may be inserted into the coupling end 26 of the second arrangement 14, and into the base structure 20 of the first arrangement 12. The attachment of the attachment device 16 to the base structure 20 may be performed using, for example, a threaded attachment. The second arrangement 14 can thus be pressed to fit against the base structure 20. As described above, the locating tabs 32 may be inserted through the slots in the second arrangement 14, thereby aiding in the press fit of the sheet. If desired, though not necessary, an adhesive may be used to enhance the press fit of the second arrangement 14 with the first arrangement.

The quality of sound in a horn assembly 10 may be effected by leaks through which air could escape from the column or shape of the second arrangement 14. Thus, it may be useful to form an airtight junction between the second arrangement 14 and the first arrangement 12 of the horn assembly 10.

In the exemplary embodiment shown in the figures, the horn assembly 10 can be sounded by blowing through the inlet tube 22 to provide a stream of air past the elastic membrane 18 and through the second arrangement 14. Again, alternate ways of providing air flow past the elastic membrane 18 may be provided.

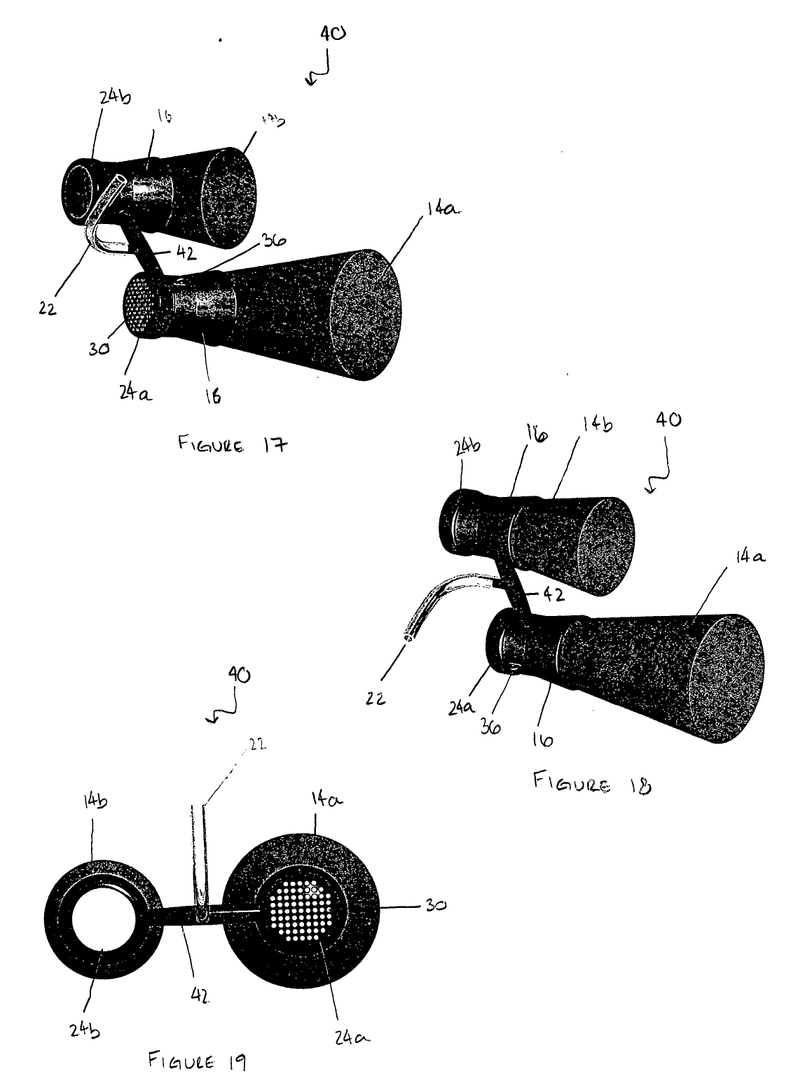

FIGS. 15-19 illustrate another exemplary embodiment of a horn assembly 40 according to the present invention having two horns 14. While two horns 14 are shown for this exemplary embodiment in these figures, any number of horns 14 may be provided. In the embodiment shown in FIGS. 15-19, an initial second arrangement 14a of a first length in the axial direction and a further second arrangement 14b of a second length in the axial direction (the second length possible varying from the first length) are provided. Thus, the horn assembly 40 may produce sounds of two pitches.

Air can be fed from through a single inlet tube 22 into two sound-generating chambers via a connecting tube 42. The sound-generating chambers are housed in the respective attachment horns 16, and can include elastic membranes 12. As shown in FIGS. 15-19, the connecting tube 42 is coupled to the attachment horns 16 via extensions 44 extending from the respective attachment horns 16. The extensions 44 can be inserted into ends of the connecting tube 42. The connecting tube 42 similarly includes an extension 46 to be received by the inlet tube 22.

Air may be fed through the inlet tube 22 by blowing into the inlet tube 22. Alternately, the inlet tube 22 may be coupled to a compressed air source for generating air flow through the inlet tube 22. Further, any other suitable arrangement for generating air flow to be passed the sound generating chambers may be implemented.

Membrane covers arrangements 24a, 24b may be provided to protect the elastic membranes 12. As shown in FIGS. 15-19, a membrane cover 24b having air vents 30 can be provided over one elastic membrane 12, while a membrane cover ring 24a with no membrane cover may be provided over the other elastic membrane 12.

The present invention thus provides an easily assembled, lightweight and relatively inexpensive horn assembly. The horn assembly is customizable with either or both of the mouthpiece, and the horn can be customizable as well. Thus, for example, a supplier may stock generic mouthpieces (preassembled or in parts), and print or manufacture customized horns for specific events.

Although the invention has been described with reference to preferred embodiments, persons skilled in the art will recognize that changes may be made in form and detail without departing from the spirit and scope of the invention.

What is claimed is:

1. A horn assembly comprising:
a first arrangement including a sound generating assembly and an attachment device; and
a second arrangement adapted to provide sound therethrough;
wherein the second arrangement is coupled to the first arrangement by pressure fitting the second arrangement to the attachment device of the first arrangement without requiring an application of an adhesive thereto.

2. The horn assembly of claim 1, wherein the first arrangement comprises a membrane and an inlet tube, the attachment device receiving the membrane and the inlet tube leading to the membrane.

3. The horn assembly of claim 2, wherein the first arrangement further comprises a base assembly supporting the membrane and the inlet tube.

4. The horn assembly of claim 3, wherein the first arrangement further comprises a horn base, and wherein the attachment device is coupled to the horn base via a threaded connection.

5. The horn assembly of claim 2, wherein the first arrangement further comprises a membrane cover to be placed over the membrane.

6. The horn assembly of claim 5, wherein the membrane cover includes air vents.

7. The horn assembly of claim 6, wherein the air vents are provided in a customizable configuration.

8. The horn assembly of claim 2, wherein the attachment device includes an extension for receipt of the inlet tube.

9. The horn assembly of claim 2, wherein a sound is generated by the horn assembly by blowing through the inlet tube.

10. The horn assembly of claim 1, wherein the second arrangement comprises a sheet of material, the sheet having a first edge and a second edge, and wherein the sheet is rolled such that at least a portion of each of the first and second edges overlap one another to form a horn shape.

11. The horn assembly of claim 10, wherein the sheet has a logo thereon.

12. The horn assembly of claim 1, wherein the second arrangement further comprises locating tabs for aiding in coupling the second arrangement to the first arrangement.

13. The horn assembly of claim 1, further comprising a lanyard holder.

14. The horn assembly of claim 13, wherein the first arrangement includes an attachment device, and wherein the lanyard holder is integral with the attachment device.

15. The horn assembly of claim 1, further comprising a further first arrangement and a further second arrangement, the further second arrangement being coupled to the further first arrangement by pressure fitting without requiring an adhesive, wherein the further second arrangement is adapted for providing sound therethrough at a different pitch from the sound of the further second arrangement.

16. The horn assembly of claim 15, wherein the further first arrangement comprises an attachment device, a membrane, and a base assembly, the attachment device receiving the membrane, the inlet tube of the first mouthpiece leading to the membrane.

17. The horn assembly of claim 15, wherein the further first arrangement and the further first arrangement are coupled to one another via a connecting tube, and wherein the inlet tube is coupled to the connecting tube.

18. The horn assembly of claim 15, wherein the further second arrangement and the further second arrangement have varying lengths from one another in an axial direction.
